(19) United States
(12) Patent Application Publication
(10) Pub. No.: US 2010/0051031 A1
(43) Pub. Date: Mar. 4, 2010

(54) HIGH-VISIBILITY FILTERING MASK

(76) Inventors: Francois Lustenberger, Plaintel (FR); Olivier de Zaiacomo, Ploeuc Sur Lie (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/373,505

(22) PCT Filed: Jul. 13, 2007
(86) PCT No.: PCT/IB2007/003082

§ 371 Date: Nov. 9, 2009

(30) Foreign Application Priority Data
Jul. 13, 2006 (FR) 06/06407

(51) Int. Cl. A62B 7/10

(52) U.S. Cl. 128/206.19

(57) ABSTRACT

The invention relates to an individual flexible, thermoformed or foldable breathing mask comprising a filtering media and an outer cover (1, 10, 11) which constitutes the cover of the mask and which protects said filtering media, characterized in that said cover is manufactured in a material having phosphorescent and/or fluorescent properties, in a sufficient quantity for the mask to be more easily visible in the dark.

The invention relates to individual flexible, thermoformed or foldable breathing masks having phosphorescent and/or fluorescent properties, such that the mask has high-visibility.

Protective breathing masks cover the mouth and nose of the wearer. Filtering masks allow filtration of the air inhaled. These masks generally comprise an outer cover or shell placed in front of a filter. This outer cover constitutes the front of the mask and protects the filtering media. To allow good breathing by the user, the outer cover must be air-permeable. Depending on the nature of the filtering media, these masks make it possible, for example, to filter dust or microorganisms, such as bacteria or viruses. Filtering masks have to fulfill the performance standards for protective respiratory devices. These standards are for example EN149, US42CFRPart84 and AS/NZS1716. EN149 is the European standard for Respiratory protective devices and filtering half masks to protect against particles.

The problem arises of making these masks visible in natural or artificial darkness (night, smoke, dark rooms, etc.).

Document GB 807,983 describes oxygen masks suitable for depressurization problems in airplanes. The body or perimeter of the mask may be soaked or treated on the surface with a fluorescent material. This document does not describe protective filtering masks. In oxygen masks, the outer shell of the mask is typically made up of a rigid material that is not air-permeable.

Document Us 2003/0075174 describes a breathing apparatus completely covering the head of the wearer. The front surface of this device is made of a transparent material not permeable by air and provided with an opening wherein a filter is placed. This device comprises a crown device which may be red, orange or fluorescent in color. This document does not describe a filtering mask comprising an outer cover protecting a filter.

WO00/72921 describes face masks provided with a ventilator. GB 2 280 620 describes outer covers for breathing masks. These documents say nothing whatsoever about fluorescence or phosphorescence characteristics.

Document US 2002/0119333 describes enamels, which may be phosphorescent, for application on laminars. These compositions are not suitable for application on filtering masks.

One solution could consist of applying fluorescent or phosphorescent bands on the visible parts of the mask. The visible parts of the mask are, for example:
an outer shell which constitutes the cover of the mask and which maintains and protects the filtering media;
a grid or similar part located on the front of the mask and which maintains and protects the filtering media;
localized structural reinforcements on the perimeter or front of the mask;
the system for fixing the mask to the face;
a nasal clip;
an exhalation valve or membrane.

But this solution complicates the production of the mask and makes the mask only partially visible. Moreover, these bands would contribute to stiffening the mask.

Another solution could consist of coloring all of the outer cover with a fluorescent or phosphorescent paint using traditional means, for example by spraying or soaking.

But this solution raises problems of the stability of the paints applied to the surface over time.

Given that one of the essential properties of the outer cover is its breathability (or air permeability), instability of the paints may also lead to inhalation of paint particles during use of the mask or loading of the filtering media with particles of paint.

Application of paints on the surface of the outer cover also presents the disadvantage of altering the porosity and therefore the breathability of this cover.

Moreover, the cover has to be light and flexible for the user's comfort.

To resolve the drawbacks of the prior art, the present invention proposes a protective breathing mask comprising an outer cover placed in front of a filtering media in which said cover is manufactured in a material colored in the mass with phosphorescent and/or fluorescent agents, in a sufficient quantity for the mask to have a high-visibility.

A first advantage of the present invention is the stability of the fluorescence and phosphorescence properties, since the material making up the outer cover is colored in the mass.

Another advantage of the present invention is that the entire surface of the outer cover is made phosphorescent or fluorescent without, however, altering the breathability properties of the outer cover.

Another advantage of the present invention is that the manufacturing process for producing the mask is not modified. For production of the outer cover, one uses directly a material colored in the mass (or in the material).

One object of the present invention is therefore a thermoformed or foldable flexible, individual protective breathing mask, which comprises a filtering media and an outer cover (1, 10, 11) which constitutes the front of the mask and which protects said filtering media, in which said outer cover is manufactured in a material colored in the mass with phosphorescent and/or fluorescent agents, in sufficient quantities for the mask to be highly visible.

According to the invention, the outer cover is manufactured in a material having phosphorescence and/or fluorescence properties, in a sufficient quantity for the mask to be highly visible. The material used for manufacturing of the outer cover is colored in the mass or in the material with phosphorescent or fluorescent agents.

High-visibility is a well-known standard for warning clothing. The filtering masks according to the present invention have high brightness/luminance factors. Preferably, the brightness/luminance factor is at least 0.70β for a yellow fluorescent mask, at least 0.40β for an orange-red fluorescent mask and at least 0.25 for a red fluorescent mask. To fulfill high-visibility standards the masks also have to comply with chromatic coordinate standards.

Preferably, the filtering masks of the present invention are light for the comfort of the user. Typically, the masks according to the present invention are disposable.

Advantageously, the masks of the present invention are disposable half masks.

In preferred embodiments, said outer cover is made up of fibers which comprise fibers which have been colored in the mass with phosphorescent or fluorescent agents having high visibility. Alternatively, the cover is made up of a phosphorescent and/or fluorescent thermoplastic or elastomeric material colored in the mass.

According to one preferred embodiment of the invention, the outer cover (1, 10, 11) is made up of fibers. These fibers include fibers in a neutral material which were colored in the mass with phosphorescent and/or fluorescent agents having high visibility. It is possible to add a fluorescent or phosphorescent agent to the fibers (polyester, polypropylene, cotton or other). Characteristically, these agents are pigments.

Advantageously, the material making up the cover is not colored by applying a layer of fluorescent or phosphorescent paint on the surface.

Preferably, the weight percent of phosphorescent and/or fluorescent agents in the fibers is between 0.01% and 40%, preferably between 0.01% and 4% and more preferably between 1% and 4%.

Typically, the fibers are chosen from the group made up of thermofusible fibers, polyester, polypropylene, cotton, bamboo, and polyamide fibers, and their mixtures.

Preferably, the outer cover (1) comprises from 30% to 100%, preferentially from 40% to 100%, from 50% to 100%, from 50% to 70% and even more preferentially from 60% to 70%, in weight, fibers having phosphorescence and/or fluorescence properties.

In one preferred embodiment, the cover comprises 65% fibers having phosphorescence and/or fluorescence properties.

In another preferred embodiment, the cover comprises 100% fibers having phosphorescence and/or fluorescence properties.

Advantageously, the fibers are distributed to make the entire exposed surface of the outer cover highly visible.

In a first embodiment of the invention, the outer cover is a thermoformed shell in non-woven material comprising 65% phosphorescent and/or fluorescent polyester fibers and 35% white, thermofusible polyester fibers.

Preferably, the non-woven material comprises 80-220 g/m² of polyester fibers. Preferentially, the non-woven material comprises 80-180 g/m², 100-160 g/m², 140-200 g/m² or 120-220 g/m² of polyester fibers.

In a specific embodiment of the invention, the mask comprises an inner shell (1′), the filtering media (1″) being placed between the outer cover (1) and the inner shell (1′).

In a second embodiment of the invention, the outer cover is a foldable shell in a non-woven material comprising 100% phosphorescent and/or fluorescent polypropylene fibers.

Preferably, the non-woven material comprises 70 to 150 g/m² preferably between 90 to 130 g/m² of fibers.

In the examples of embodiments, the fibers of the outer cover are made up, as desired, of:
40% in weight of thermofusible polyester fibers and 60% phosphorescent and/or fluorescent polyester fibers;
35% in weight of thermofusible polyester fibers and 65% in weight of phosphorescent and/or fluorescent polyester fibers.

The thermofusible polyester fibers preferably have a melting point of 110° C. and a DTex close to 5.

The phosphorescent or fluorescent fibers are also polyester fibers having a melting point of 250° C. and a DTex close to 8. It may also be a mixture of polyester fibers having a melting point of 250° C. and a DTex close to 8 or close to 3.

In another embodiment, the cover is made up of fluorescent and/or phosphorescent polypropylene fibers.

It is moreover recommended by the invention to make the system for fixing the mask to the face phosphorescent and/or fluorescent: braid, knitted straps, woven straps, elastic straps, fibrillated film (natural rubber, synthetic rubber, polyurethane, etc.) or elastic (natural rubber, synthetic rubber, polyurethane, etc.).

In a variation, the mask comprises, in the front, a grid in synthetic resin (thermoplastic material and/or elastomeric material) which contains fluorescent and/or phosphorescent pigments.

In a variation, the mask comprises fluorescent or phosphorescent elastomer reinforcements.

For masks comprising an exhalation valve or membrane (3) and/or a nasal clip (2): it is advantageous to add a fluorescent or phosphorescent coloring to the exhalation valve or to the nasal clip.

The attached drawing diagrammatically illustrates embodiments of the invention. In the figures:

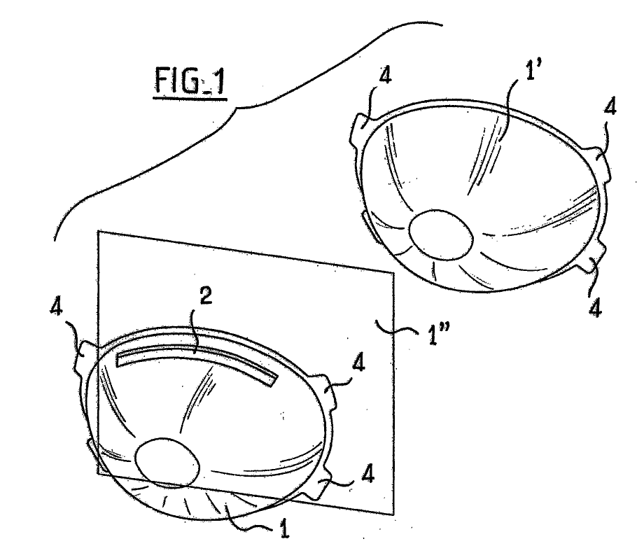

FIG. 1 is an exploded diagrammatic view of a thermoformed mask;

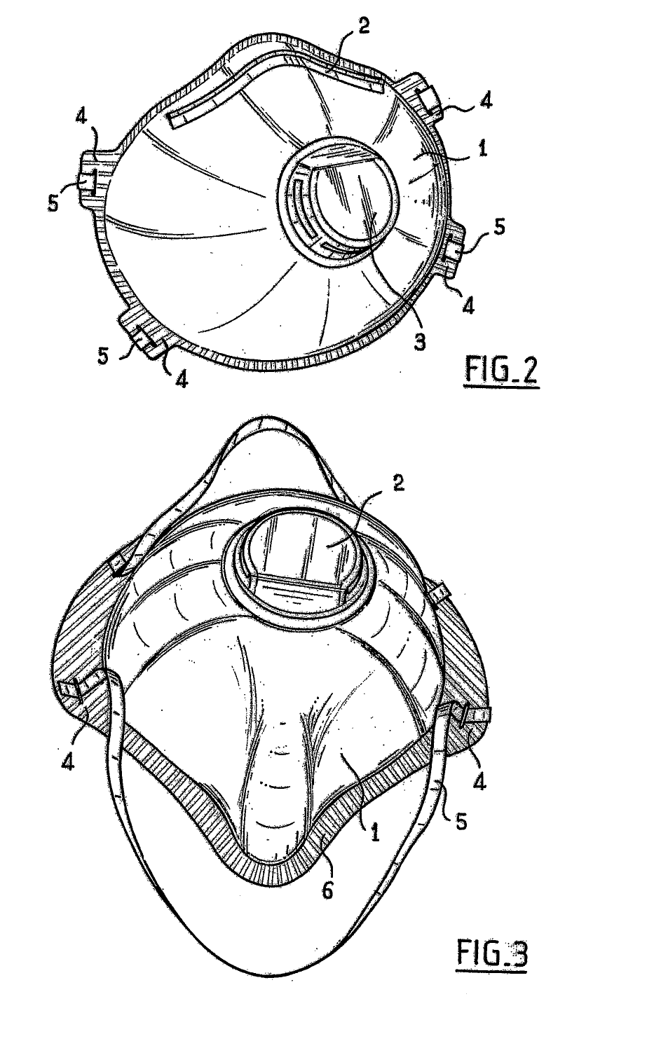

FIG. 2 is a front view of one embodiment of a thermoformed mask;

FIG. 3 is a front view of a variation of the thermoformed mask;

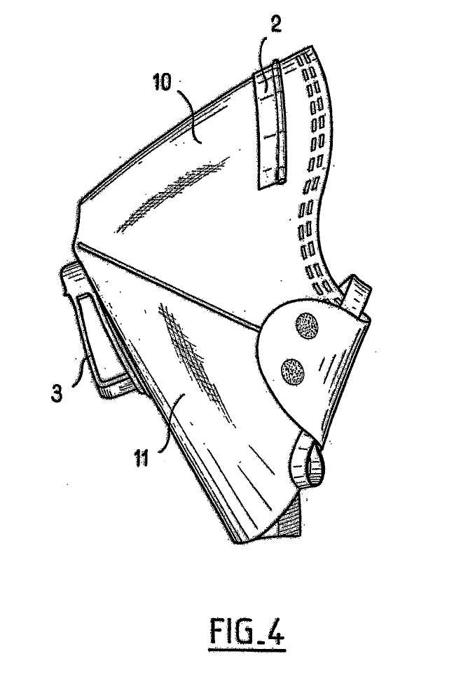

FIG. 4 is a side view of a foldable mask, in the unfolded state;

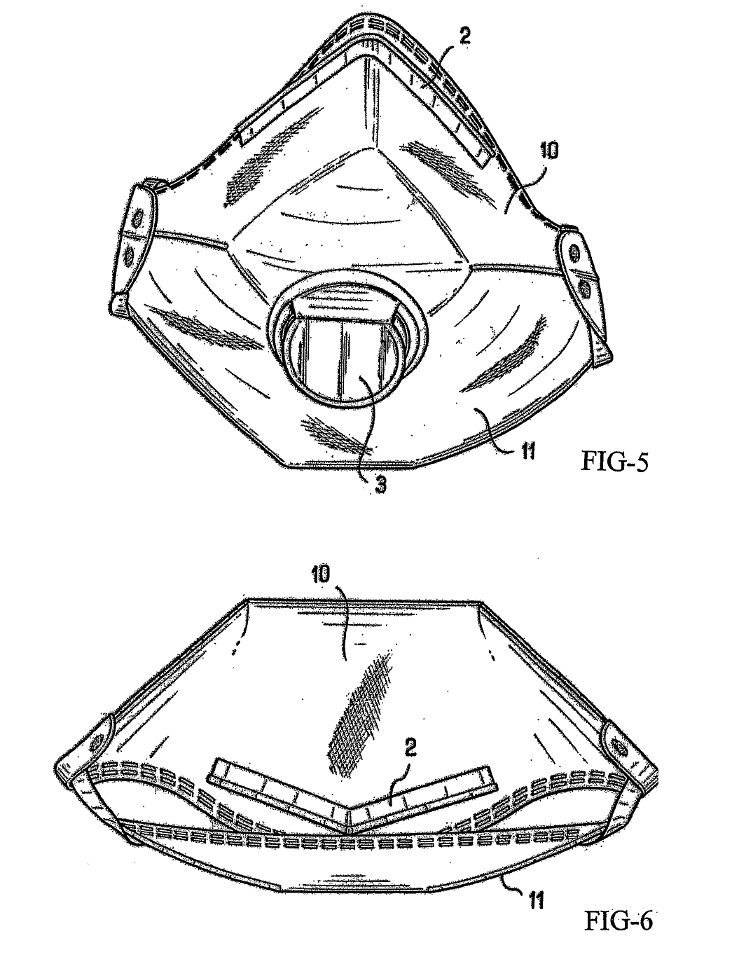

FIG. 5 is a front view of the mask of FIG. 4, and

FIG. 6 is a view of the mask of FIG. 4 in the folded state.

FIG. 1 is an exploded schematic diagram of a mask made up of two thermoformed shells (1, 1′) and an intermediate filtering media (1″) illustrated by a sheet but which in reality fits the shape of the shells between which it is held.

The mask in FIG. 2 presents, seen from the front, the outer cover (1), the nasal clip (2), the valve (3), and ears (4) for catching the fixing straps (5) of a mask.

Behind the outer cover, the mask comprises an inner shell and a filtering media contained between the two shells.

The two shells are modeled such that the mask may be applied on the face.

They are, for example, in non-woven fibers.

FIG. 3 is a layered perspective front view of one embodiment of the mask of FIG. 2 without a nasal clip but with a reinforcing contour (6).

The foldable mask shown in the unfolded state in FIGS. 4 and 5 comprises an upper panel (10) provided with a nasal clip (2) and a lower panel (11) provided with a valve (3). These two panels are trapezoidal in shape.

This mask is seen in the folded state in FIG. 6.

The invention is not limited to the embodiments described.

### EXAMPLES

### Example 1

Example 1 describes a single use respirator according to FIG. 2.

The general body of the single use respirator comprises an outer cover, a filtering media and an inner shell.

1) The outer cover is made of polyester fibers (non-woven mechanically bonded by needlepunching between 80 and 180 g/m²): 65% PES fibers (8 DTex) which are fluorescent and/or phosphorescent in the core of the fiber and 35% thermofusible PES fibers (5 DTex) which are white. The PES (polyester) fibers have a melting point of 250° C. whereas the thermfusible PES fibers have a melting point of 110° C.
2) The filtering media is made of white polypropylene fibers. The non-woven material is made using the meltblowing process, then the fibers are electrostatically charged (between 20 and 200 g/m² depending on the filtering efficiency requested).
3) The inner shell is made of polyester fibers (non-woven mechanically bonded by needlepunching between 80 and 180 g/m²): 65% white classical PES fiber (8 DTex) and 35% white thermofusible PES fiber (5 DTex).

### Example 2

Example 2 describes another single use respirator according to FIG. 2.

As previously, the general body of the single use respirator comprises an outer cover, a filtering media and an inner shell.

1) The outer cover is made of polyester fiber (non-woven mechanically bonded by needlepunching between 80 and 180 g/m²): 35% fluorescent PES fibers (8 DTex), 30% fluorescent PES fibers (3.2 DTex) and 35% white thermofusible PES fibers (5 DTex).
2) The filtering media is made of white polypropylene fibers. The non-woven material is made using the meltblowing process, then the fibers are electrostatically charged (between 20 and 200 g/m² depending on the filtering efficiency requested).
3) The inner shell is made of polyester fibers (non-woven mechanically bonded by needlepunching between 80 and 180 g/m²): 35% white PES fibers (8 DTex), 30% white PES fibers (3.2 DTex) and 35% white thermofusible PES fibers (5 DTex).

### Example 3

Example 3 describes a single use respirator according to FIG. 3.

The general body of the single use respirator comprises an outer cover, a filtering media and an inner shell.

1) The outer cover is made of polyester fibers (non-woven mechanically bonded by needlepunching between 120 and 220 g/m²): 65% phosphorescent PES fibers (8 DTex) and 35% white thermofusible PES fibers (5 DTex).
2) The filtering media is made of white polypropylene fiber. The non-woven material is made using the meltblowing process, then the fibers are electrostatically charged (between 20 and 200 g/m² depending on the filtering efficiency requested).
3) The inner shell is made of white polypropylene fibers. The non-woven material is made using the spunbond process (between 10 and 50 g/m²).

### Example 4

Example 4 describes a single use respirator according to FIG. 4.

The general body of the single use respirator comprises an outer cover, a filtering media and an inner shell.

1) The outer cover is made of polypropylene fibers: 100% of the fibers are fluorescent and/or phosphorescent in the core. The non-woven material is made using the spunbond process (between 70 and 150 g/m² depending on the product).
2) The filtering media is made of white polypropylene fibers. The non-woven material is made using the meltblowing process, then the fibers are electrostatically charged (between 20 and 200 g/m² depending on the filtering efficiency requested).

The inner shell is made of white polypropylene fibers. The non-woven material is made using the spunbond process (between 10 and 50 g/m²).

### Example 5

The manufacturing process for the moulded masks comprises the following steps:

### a) Thermoforming

The non-woven material is heated between two drying ovens (220° C.) and then preformed by a press (7 bar) between two moulds in order to give the shape to the future mask.

### b) Ultrasonic Welding

The ultrasonic welding technology is used to weld the perimeter of the mask, to ensure the holding of the filter media on the non-woven material and to weld the nose bridge and the valve onto the shell. The two parts to be welded are submitted to low amplitude and high frequency vibrations via a sonotrode (frequency 20000 Hz, pressure 6 bar). The resulting friction overheats the matter until melting which allows welding.

### c) Cutting

Cutting tools are used for cutting of the perimeter of the masks and cutting of the filtering media. The material is cut under a press (6 bar) according to the required shape, by shearing between the male and female cutting tools.

### d) Stapling of the Elastics on the Masks

### Example 6

The chromatic coordinates and the brightness factor were measured for two molded masks. The masks of the present invention fulfill the requirements of European performance standard EN471:2003 for High-visibility garments. The results are shown below:

| | | | brightness |
|---|---|---|---|
| | chromatic coordinate | | factor |
| | x(D65) | y(D65) | β(D65) (%) |
| Molded mask yellow fluorescent | 0.3621 | 0.5339 | 115.6 |
| Molded mask orange fluorescent | 0.5202 | 0.3392 | 65.9 |

1. Individual flexible, thermoformed or foldable breathing mask comprising a filtering media and an outer cover which constitutes the front of the mask and which protects said filtering media, wherein said outer cover is manufactured in a material colored in the mass with phosphorescent and/or fluorescent agents, in a sufficient quantity for the mask to have a high visibility.

2. Mask according to claim 1 wherein said cover is made up of fibers, said fibers comprising fibers of neutral material which have been colored in the mass with phosphorescent agents and/or fluorescent agents having a high visibility.

3. Mask according to claim 2, wherein the weight percent of the phosphorescent and/or fluorescent agents in the fibers is from 0.01% to 4%.

4. Mask according to one of claims 2-3, wherein said fibers are chosen from the group made up of thermofusible fibers, fibers in polyester, polypropylene, cotton, bamboo, or polyamide, and their mixtures.

5. Mask according to claim 2, wherein the outer cover comprises from 50% to 100% in weight of fibers having phosphorescent and/or fluorescent properties.

6. Mask according to claim 2, wherein said fibers are distributed to make the entire exposed surface of the outer cover highly visible.

7. Individual flexible, thermoformed or foldable breathing mask according to claim 1, wherein the outer cover is a thermoformed shell in a non-woven material comprising 65% phosphorescent and/or fluorescent polyester fibers and 35% white, thermofusible polyester fibers.

8. Mask according to claim 7, wherein the non-woven material comprises 80-220 g/m² of fibers.

9. Mask according to one of claims 7-8, wherein it comprises an inner shell, the filtering media being inserted between the outer cover and the inner shell.

10. Individual flexible, thermoformed or foldable breathing mask according to claim 1, wherein the outer cover is a foldable shell in a non-woven material comprising 100% phosphorescent and/or fluorescent polypropylene fibers.

11. Mask according to claim 10, wherein the non-woven material comprises 70 to 150 g/m² of fibers.
